(19) United States
(12) Patent Application Publication
(10) Pub. No.: US 2009/0289148 A1
(43) Pub. Date: Nov. 26, 2009

(54) Faired tether for wind power generation systems

(75) Inventors: Saul Griffith, San Francisco, CA (US); Peter Lynn, Alameda, CA (US); Don Montague, Maui, HI (US); Corwin Hardham, San Francisco, CA (US)

Correspondence Address: VAN PELT, YI & JAMES LLP, 10050 N. FOOTHILL BLVD #200, CUPERTINO, CA, 95014, US

(73) Assignee: MAKANI POWER, INC.

(21) Appl. No.: 12/154,685

(22) Filed: May 23, 2008

(51) Int. Cl. B64C 31/06

(52) U.S. Cl. 244/155 R

(57) ABSTRACT

A tether for a kite wind power system is disclosed. The tether has a cross-section that is designed to have less aerodynamic drag than a tether with a circular-shaped cross-section.

### BACKGROUND OF THE INVENTION

Power can be extracted from wind using a kite. In some kite wind power systems, the kite is used to turn a generator. The kite is coupled to the generator using a tether. Because wind force increases with altitude, in order to take advantage of high wind forces at high altitudes a kite tether must be long enough to reach these high altitudes. One problem with a long tether is that it is a significant source of drag as the kite moves in response to the wind. As drag increases in the kite, there is a reduction in the amount of power that the kite is able to extract.

### BRIEF DESCRIPTION OF THE DRAWINGS

Various embodiments of the invention are disclosed in the following detailed description and the accompanying drawings.

FIG. 1 is a block diagram illustrating an embodiment of a wind power system.

FIG. 2 is a diagram illustrating an embodiment of a cross-section of a faired tether.

FIG. 3A is a diagram illustrating an embodiment of a tether cross-section with flexural skins located on the tether surface.

FIG. 3B is a diagram illustrating an embodiment of a tether cross-section with flexural skins located on the tether surface.

FIG. 4 is a diagram illustrating an embodiment of a tether cross-section with flaps coupled on a tether surface.

FIG. 5 is a diagram illustrating an embodiment of a tether cross-section with a tail flap.

FIG. 6 is a diagram illustrating an embodiment of a tether cross-section with inlet holes and outlet holes.

FIG. 7 is a diagram illustrating an embodiment of a tether cross-section with an internal shaft.

FIG. 8 is a diagram illustrating an embodiment of a tether cross-section with the center of rotation forward of the aerodynamic center.

FIG. 9 is a diagram illustrating an embodiment of a tether cross-section with an extended tail fin.

FIG. 10A is a diagram illustrating an embodiment of a tether cross-section with a static tail design.

FIG. 10B is a diagram illustrating an embodiment of a tether cross-section with a static tail design.

FIG. 10C is a diagram illustrating an embodiment of a tether cross-section with a static tail design.

FIG. 10D is a diagram illustrating an embodiment of a tether cross-section with a static tail design.

FIG. 11A is a diagram illustrating an embodiment of a tether cross-section with a flexible tail design.

FIG. 11B is a diagram illustrating an embodiment of a tether cross-section with a flexible tail design.

FIG. 11C is a diagram illustrating an embodiment of a tether cross-section with a flexible tail design.

FIG. 11D is a diagram illustrating an embodiment of a tether cross-section with a flexible tail design.

FIG. 12 is a diagram illustrating an embodiment of a tether with passive tail flaps.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A faired tether for a kite wind power system is disclosed. A kite is used to couple energy from the wind, which is transferred to the ground through a tether. In various embodiments, the power is transmitted to the ground by either mechanical or electrical means through the tether, or by any other means. In a kite wind power system where the motion of the kite is used to extract energy from the wind, aerodynamic drag on the tether is a significant source of energy loss. Designing the tether (e.g., the tether cross-section) to minimize aerodynamic drag reduces this energy loss. The resulting tether is wing-shaped, or “faired”.

A wing shape only minimizes aerodynamic drag if it is aligned appropriately with respect to the wind. If the wind direction or the angle of tether motion relative to the wind changes, aerodynamic drag on the tether will increase. Also, it is possible for wind energy to stimulate the tether's vibration modes. Energy losses due to an offset angle faired tether and/or tether vibration modes can be worse than losses from a simple cylindrically-shaped tether, negating the advantages of the tether being faired. Therefore, in order to achieve the advantages of the faired tether, the tether needs to be designed such that it aligns appropriately with respect to the wind and remains stably aligned.

Many methods are possible for ensuring stable alignment of the tether with respect to the wind. One class of methods for ensuring stable alignment is passive methods, where the design of the tether is such that it naturally tends (e.g., passively tends) to return to stably aligning with the wind. These methods are inexpensive and robust to failure. In various embodiments, a passive method for a tether design comprises a design in which the design of the weight distribution in the tether is such that the center of rotation is forward of the aerodynamic center, the design uses fixed flaps or deformable flexural skins on the tether surface, the design uses bleed holes that traverse the thickness of the tether, the design includes a faired outer casing that rotates freely with respect to an inner cylindrical tether core on a bearing, or any other appropriate design that passively aligns with respect to the wind. Another class of methods for ensuring stable alignment is active methods, where an active control system causes the tether to stably align the tether with respect to an incident wind. These active methods are more complex and expensive, but can lead to a greater reduction of drag for the tether compared to passive methods and thus yield a more efficient kite wind power generating system which enables higher power output. In various embodiments, active methods of controlling tether angle include controlling a faired tether's alignment with the wind using powered flaps on the tether surface, using powered flaps attached to the trailing edge, using controllable flexural skins on the tether surface, using active control of the tether angle with respect to a fixed internal shaft, or any other appropriate active method. In some embodiments, the tether is designed to stably align itself with respect to an incident wind using a combination of active and passive means.

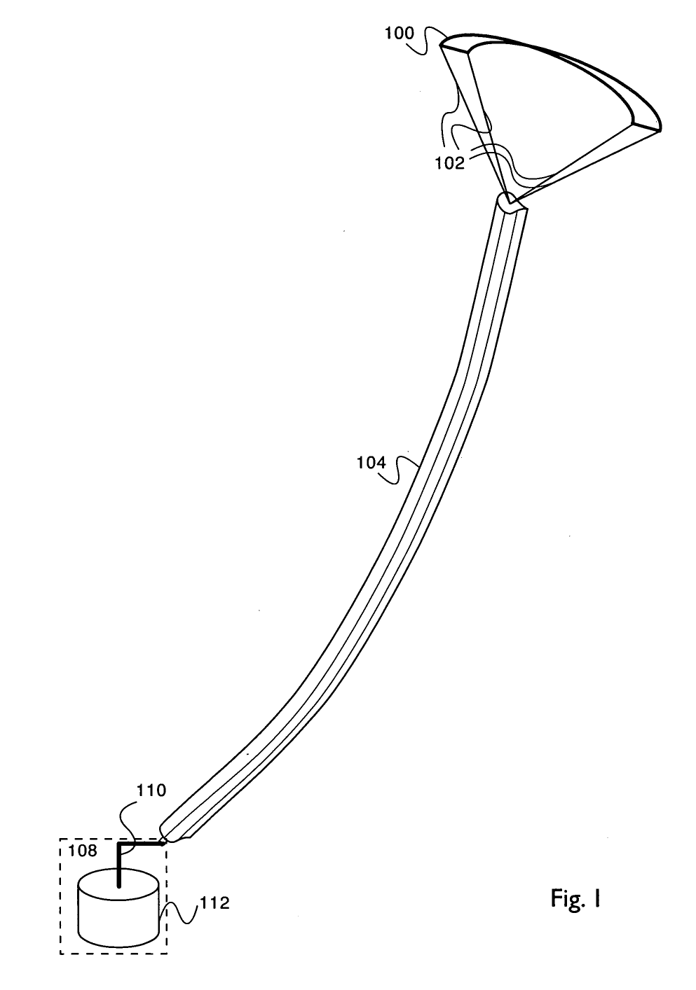

FIG. 1 is a block diagram illustrating an embodiment of a wind power system. In the example shown, kite 100 is coupled to tether 104 through kite linkage 102. Kite 100 comprises a structure designed to capture wind. In some embodiments, kite 100 is comprised of fabric produced (e.g., cut and sewn) to achieve a desired shape upon being subjected to wind. In various embodiments, kite linkage 102 comprises cloth lines, metal wires, inflexible bars, or any other appropriate kite-to-tether linkage. In the example shown, tether 104 is designed to minimize aerodynamic drag. In some embodiments, the tether cross-section changes over the length of the tether. In various embodiments, tether 104 is comprised of material that is stiff, flexible, able to twist, or any other appropriate longitudinal or torsional stiffness. In various embodiments, tether 104 is solid, hollow, or solid with a hollow channel for electrical or mechanical connections.

Ground station 108 comprises crankarm 110 and power extractor 112. The force of wind captured by kite 100 is transferred through crankarm 110 to power extractor 112, generating power as the kite flies in a circular path.

Many different power extraction configurations are possible. In various embodiments, the wind power system extracts power in cycles as the kite pulls out a tether in a traction phase and the power system recovers the tether in a recovery phase, the wind power system extracts power with wind turbines located on the kite, or the wind power system extracts power using any other appropriate method.

In some embodiments, the kite wind power system is designed to reduce modes of the tether vibrating and/or oscillating as it is blown by the wind. In some embodiments, reduction of vibrating and/or oscillating modes is accomplished by designing the tether such that it stably aligns itself with respect to the wind by changing its alignment in response to lift.

In some embodiments, tether 104 comprises a tether that is not homogeneous along its length in order to suppress vibration/oscillatory/resonant modes. For example, the configuration of the tether changes along the tether length: features are included along part of the length and not along other parts, the tether cross section is different in one part of the tether length compared to another part of the tether length, different active or passive methods for controlling tether position are located along different positions of the tether length, or any other appropriate configurations to stably align the tether with respect to the wind.

In some embodiments, the tether is able to twist or otherwise deform/move such that the tether has different alignments at different positions along its length to allow alignments with wind that has different orientations at different altitudes.

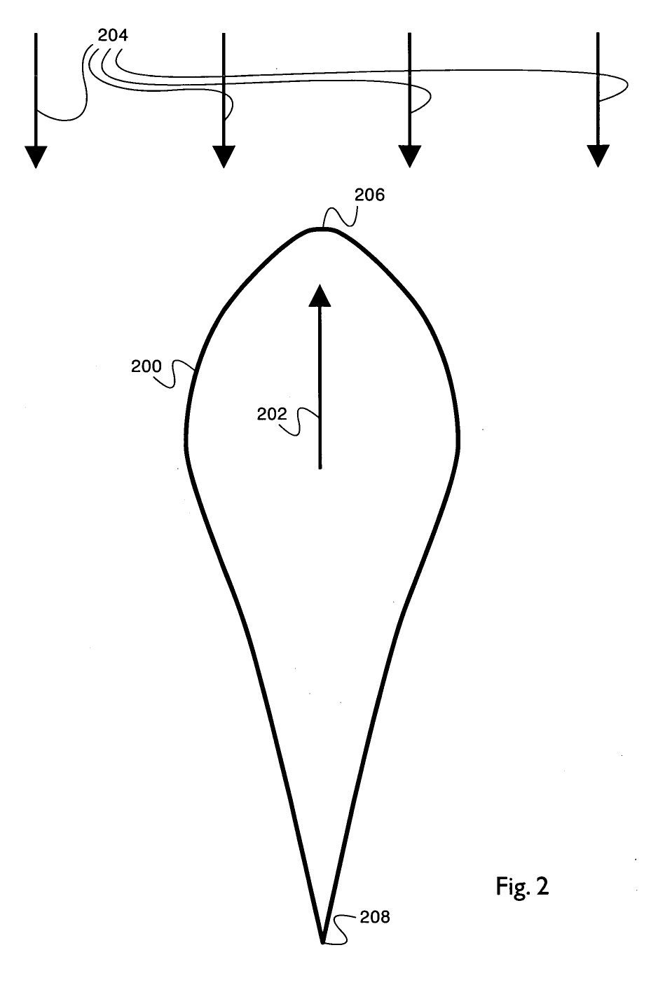

FIG. 2 is a diagram illustrating an embodiment of a cross-section of a faired tether. In some embodiments, tether cross-section 200 represents a cross-section of tether 104 of FIG. 1. In the example shown, tether cross-section 200 is aligned along arrow 202, towards the top of the page. Relative to tether cross-section 200, wind as seen by tether cross-section 200 is in the direction indicated by arrows 204, towards the bottom of the page. Wind makes contact with tether cross-section 200 at leading edge 206, travels along the surface of tether cross-section 200, and leaves at trailing edge 208. Tether cross-section 200 is designed to reduce aerodynamic drag from wind as compared to a circular cross section tether. When the wind and tether cross-section are not aligned appropriately (e.g., arrow 204 and arrow 202 are not parallel and in opposite directions), then the tether experiences a force due to the wind (e.g., in a direction perpendicular to 202 or towards the left or right of the page illustrating FIG. 2).

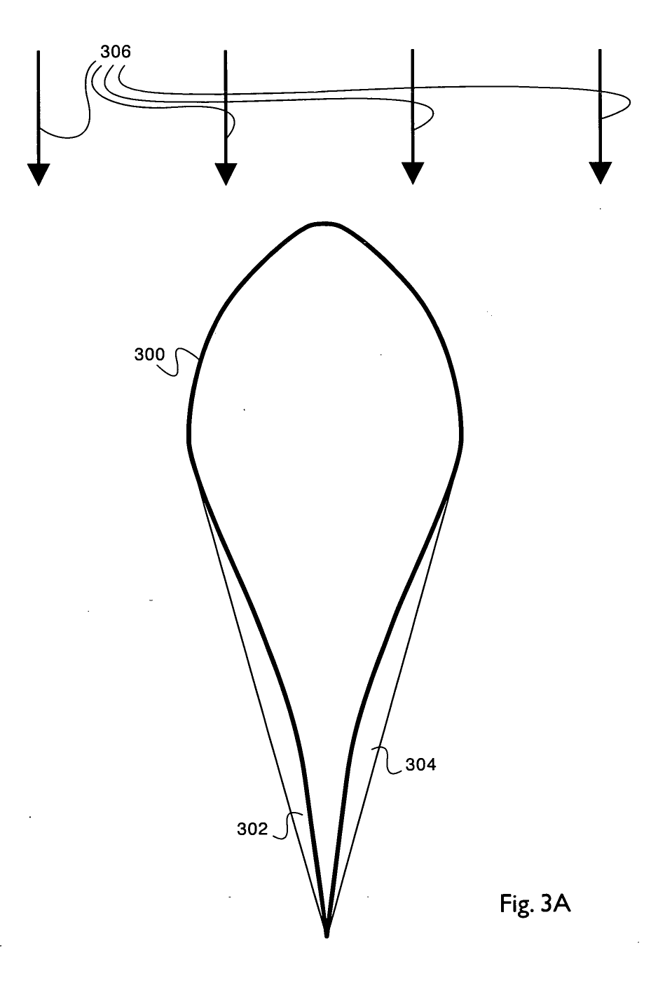

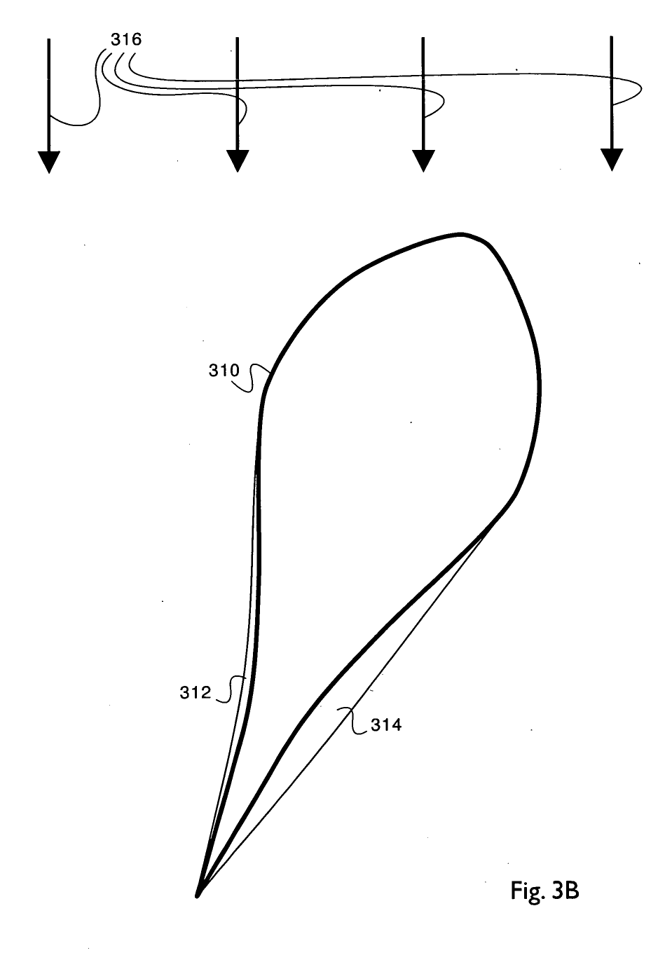

FIG. 3A is a diagram illustrating an embodiment of a tether cross-section with flexural skins located on the tether surface. In some embodiments, the tether cross-section of FIG. 3A implements a passive method for stable alignment of a tether. In the example shown, wind points at tether cross-section 300 in the direction indicated by arrows 306, towards the bottom of the page. Flexural skins 302 and 304 are coupled to positions located symmetrically with respect to cross-section 300, on the trailing side. In some embodiments, the material comprising flexural skins 302 and 304 changes shape in response to a gradient in air pressure. If the tether cross-section is aligned with respect to the incident wind (i.e., if the line from the leading edge to the trailing edge is parallel to the direction of the wind) the flexural skins will change shape in a symmetrical way (i.e., flexural skin 302 is the same shape as flexural skin 304) so that no realignment force is experienced by tether cross-section 300 so that the tether cross-section 300 stably remains aligned with the wind. In the event that the tether cross-section is not aligned with respect to the incident wind, the flexural skins will change shape in an asymmetrical way (i.e., flexural skin 302 changes to a different shape than flexural skin 304), resulting in a different air pressure on the two sides of tether cross-section 300. The air pressure difference causes tether cross-section 300 to realign with respect to the incident wind. In some embodiments, in the event that the tether is not aligned with respect to an incident wind, flexural skins 302 and 304 are controlled by the active control system in such a way as to cause a realignment of the tether with respect to the incident wind. In various embodiments, the shape of flexural skins 302 and 304 is set by an active pressure controller controlling the pressure within the skins, by a piezoelectric actuator or actuators, by an electrostatic actuator or actuators, by a pneumatic actuator or actuators, or by any other appropriate technique for modifying the shape of the flexural skins.

FIG. 3B is a diagram illustrating an embodiment of a tether cross-section with flexural skins located on the tether surface. In the example shown, wind points at tether cross-section 310 in the direction indicated by arrows 316, towards the bottom of the page. Tether cross-section 310 is aligned at an angle to the wind. The pressure differential from the oncoming wind has compressed flexural skin 312 and allowed flexural skin 314 to expand. The change in tether cross-section moves the tether aerodynamic center and causes air pressure to rotate the tether such that it is aligned in the direction of the oncoming wind.

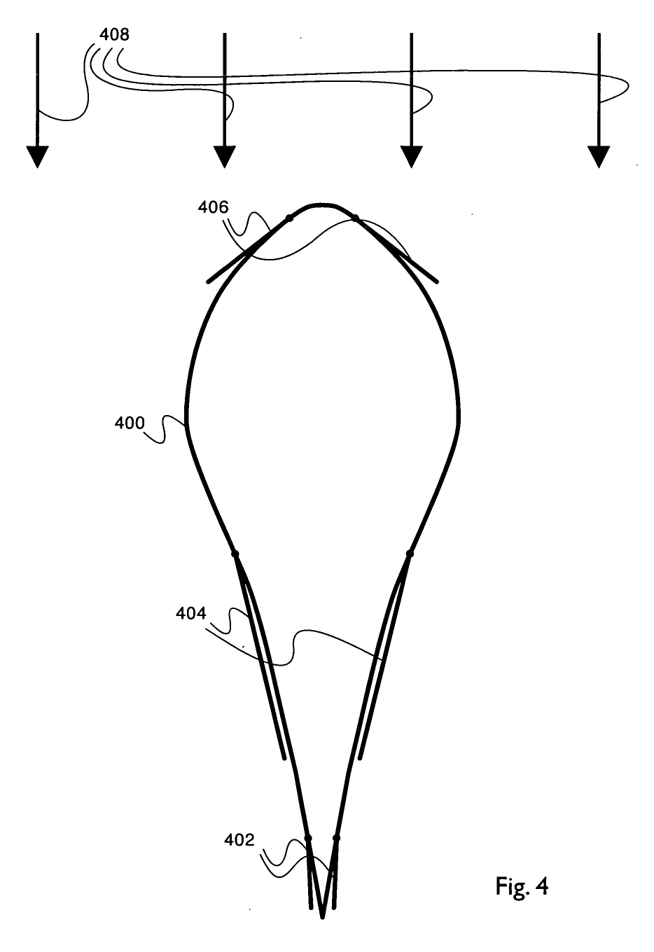

FIG. 4 is a diagram illustrating an embodiment of a tether cross-section with flaps coupled on a tether surface. In some embodiments, the tether cross-section of FIG. 4 implements an active method for stable alignment of a tether. In the example shown, wind points at tether cross-section 400 in the direction indicated by arrows 408, towards the bottom of the page. In various embodiments, pairs of flaps are coupled on the tether surface at a trailing edge, indicated by flap pair 402; centrally, indicated by flap pair 404; at a leading edge, indicated by flap pair 406; or any other appropriate location on the tether surface. In some embodiments, there is only one flap located on the tether surface. In various embodiments, the flaps are allowed to move freely or are fixed at a predetermined angle. In some embodiments, in the event that the tether is not aligned with respect to an incident wind, the angle of the flaps is controlled by the active control system in such a way as to cause a realignment of the tether with respect to the incident wind

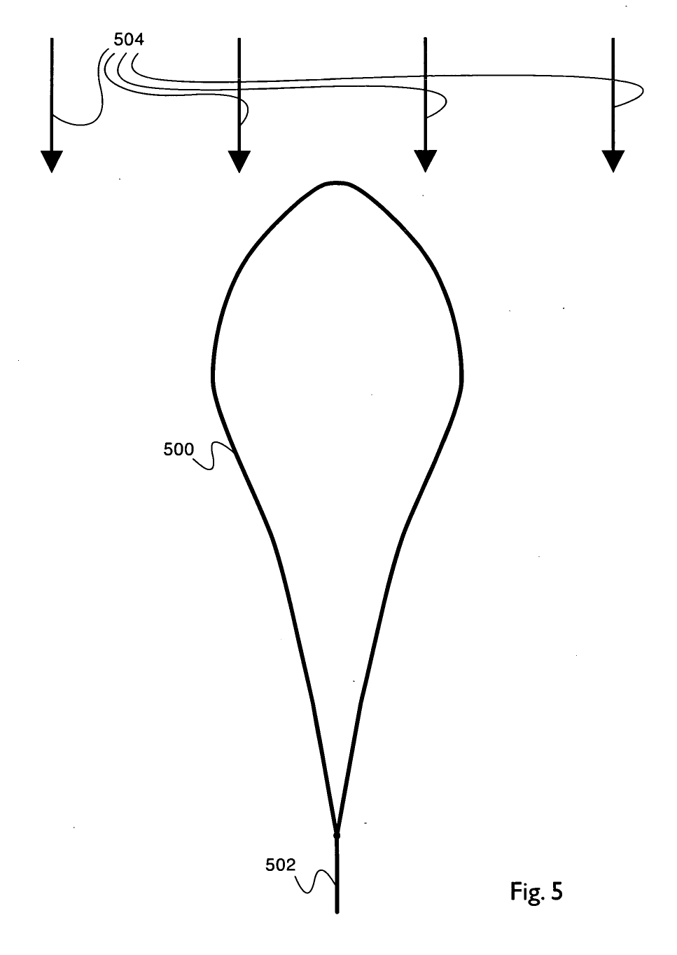

FIG. 5 is a diagram illustrating an embodiment of a tether cross-section with a tail flap. In some embodiments, the tether cross-section of FIG. 5 implements an active method for stable alignment of a tether. In the example shown, wind points at tether cross-section 500 in the direction indicated by arrows 504, towards the bottom of the page. Tail flap 502 is located at a trailing edge of cross-section 500 and is angled nominally parallel with the wind. In some embodiments, tail flap 502 is fixed at an angle parallel to the line from the leading edge to the trailing edge of tether cross-section 500. In some embodiments, in the event that the tether is not aligned with respect to an incident wind, the angle of tail flap 502 is controlled by the active control system in such a way as to cause a realignment of the tether with respect to the incident wind.

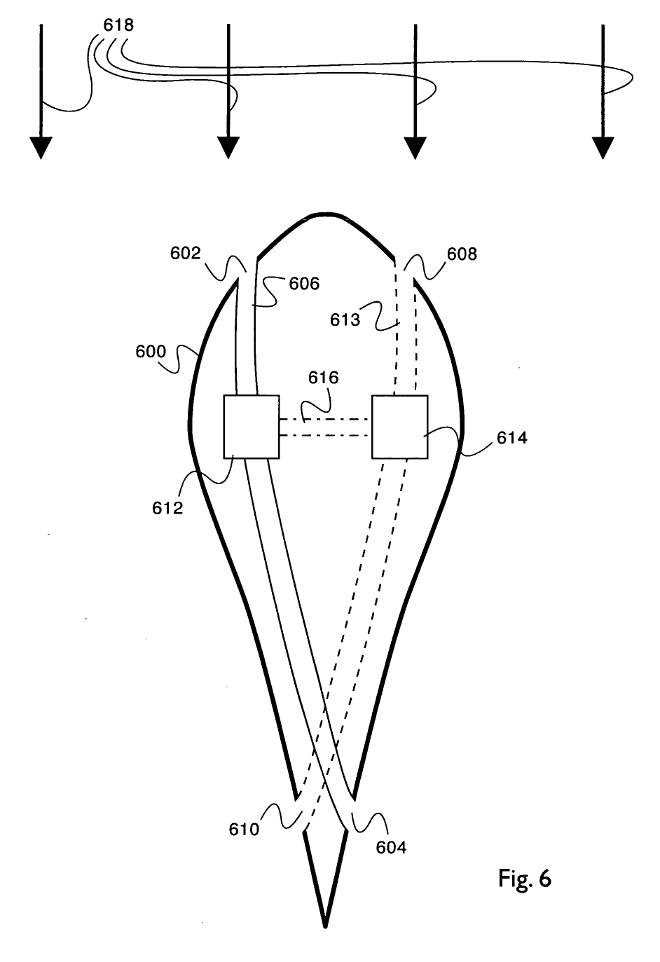

FIG. 6 is a diagram illustrating an embodiment of a tether cross-section with inlet holes and outlet holes. In some embodiments, the tether cross-section of FIG. 6 implements a passive method for stable alignment of a tether. In the example shown, wind points at tether cross-section 600 in the direction indicated by arrows 618, towards the bottom of the page. Inlet hole 602 and outlet hole 604 are cut into tether cross-section 600. Coupler 606 couples inlet hole 602 with outlet hole 604, traversing from one side of the tether to the other to connect the air pressure at the leading edge of the tether with the air pressure at the opposite side of the trailing edge. Inlet hole 608 and outlet hole 610 are also cut into tether cross-section 600, symmetrically to inlet hole 602 and outlet hole 604. Coupler 613 couples inlet hole 608 with outlet hole 610. If the tether is aligned with an incident wind, the pressure associated with inlet holes 602 and 608 will be equal, therefore the pressure associated with outlet holes 604 and 610 will be equal, and the tether will not change alignment. In the event that the tether is aligned at an angle to an incident wind, air pressure associated with inlet holes 602 and 608 causes air pressure associated with outlet holes 604 and 610 to align the tether with respect to an incident wind. In some embodiments, coupler 606 includes fluidic logic unit 612 and coupler 613 includes fluidic logic unit 614. Fluidic logic unit 612 causes the pressure associated with outlet hole 604 to change as a function of the pressure associated with inlet hole 602. In various embodiments, fluidic logic unit 612 causes the pressure associated with inlet hole 602 and the pressure associated with outlet hole 604 to have a directly proportional relationship, an inversely proportional relationship, a nonlinear relationship, or any other appropriate relationship. Inlet hole 608, outlet hole 610, coupler 606, and fluidic logic unit 614 are designed similarly to inlet hole 602, outlet hole 604, coupler 613, and fluidic logic unit 612. Coupler 606 and coupler 613 are positioned so that they couple to their appropriate inlet/outlet holes. In some embodiments, coupler 616 couples fluidic logic units 612 and 614, allowing appropriate relationships between pressures associated with inlet 602 and inlet 608 and pressures associated with output 604 and 610 to be achieved.

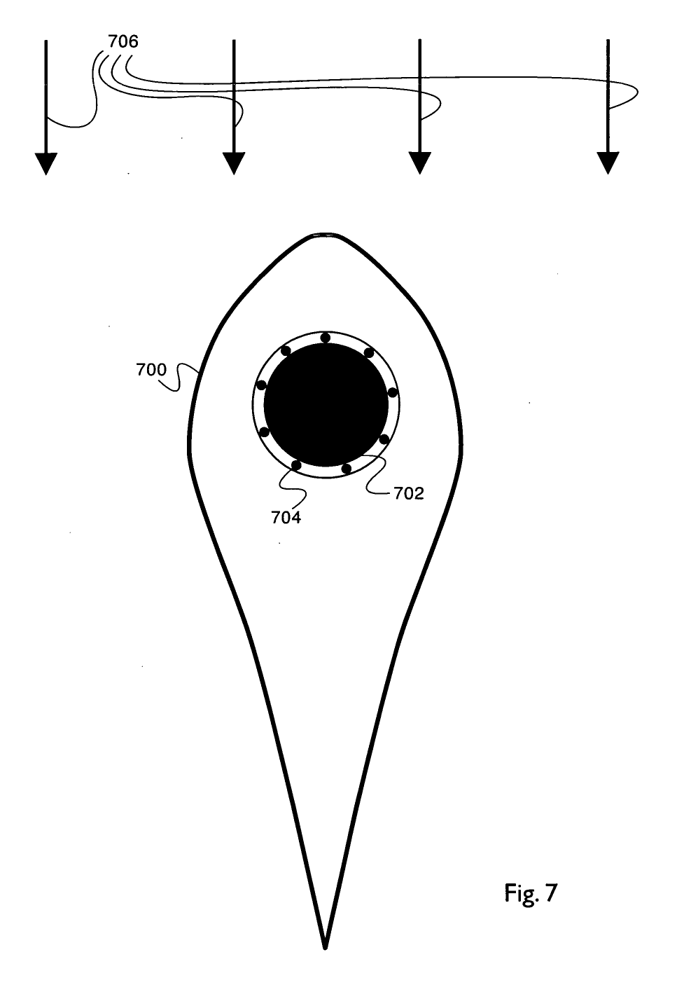

FIG. 7 is a diagram illustrating an embodiment of a tether cross-section with an internal shaft. In some embodiments, the tether cross-section of FIG. 7 implements a passive method for stable alignment of a tether. In the example shown, wind points at the tether cross-section in the direction indicated by arrows 706, towards the bottom of the page. Bearing 704 enables tether body 700 to rotate freely around shaft 702. In some embodiments, tether 700 is designed such that air pressure from the oncoming wind will always cause it to turn such that it is aligned with the wind. Bearing 704 minimizes the resistance to the tether turning and allows it to more effectively align itself with the wind.

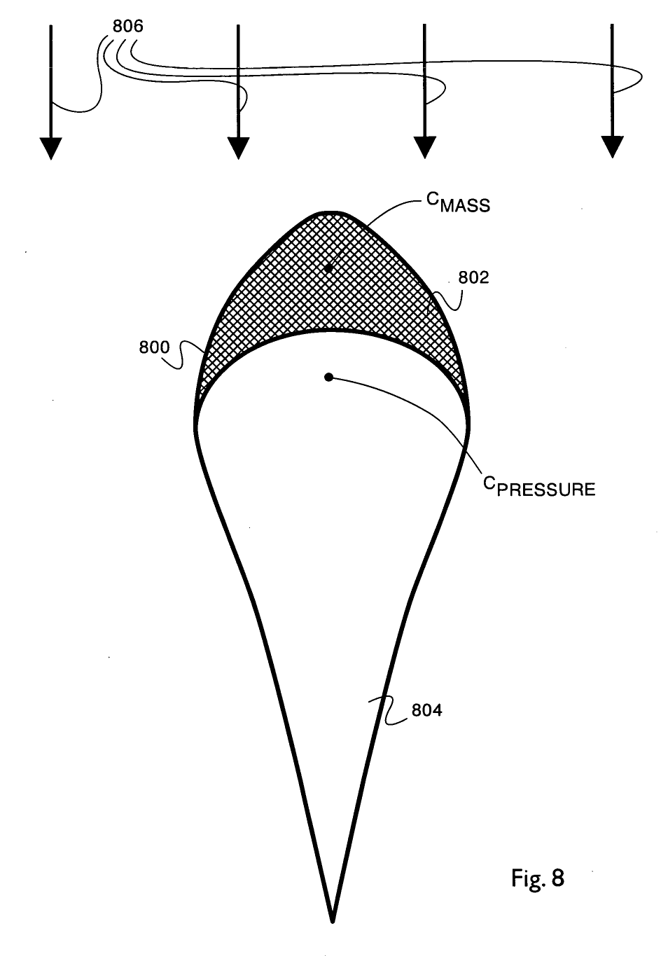

FIG. 8 is a diagram illustrating an embodiment of a tether cross-section with the center of rotation forward of the aerodynamic center. In some embodiments, the tether cross-section of FIG. 8 implements a passive method for stable alignment of a tether. In the example shown, wind points at tether cross-section 800 in the direction indicated by arrows 806, towards the bottom of the page. Forward region 802 is made from dense material, and rear region 804 is made from light material. The tether center of rotation is therefore towards the front of the tether, as indicated in the diagram. Tether rotation will tend to be centered at the tether center of rotation. The tether aerodynamic center is determined by its surface shape, and is behind the center of rotation. Pressure from oncoming wind acts on the tether at the tether aerodynamic center. Because the center of rotation is located forward of the aerodynamic center, in the event that the tether is not aligned with respect to an incident wind, air pressure will cause a realignment with respect to the incident wind.

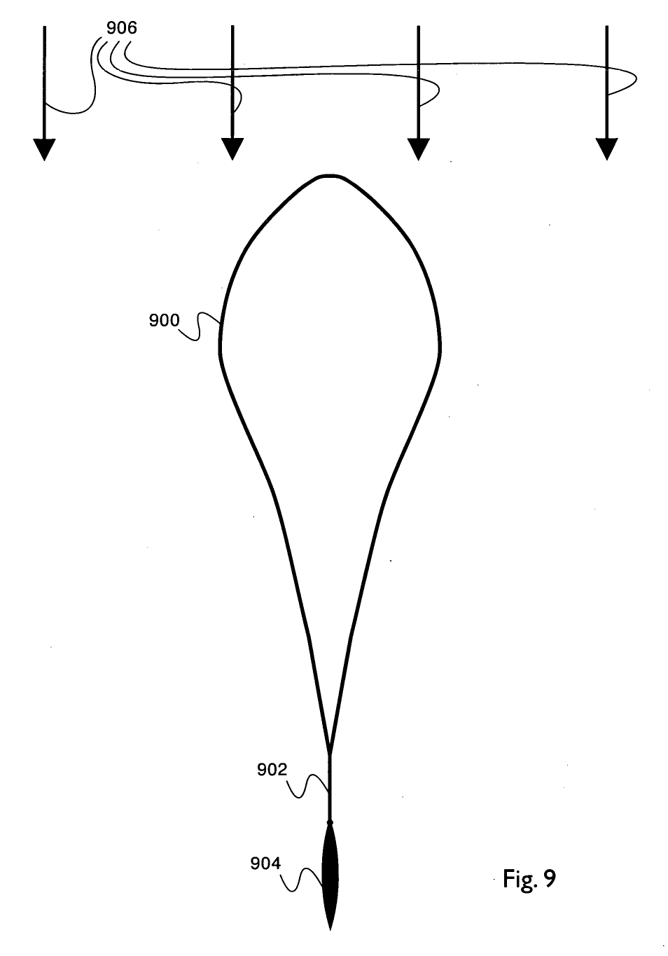

FIG. 9 is a diagram illustrating an embodiment of a tether cross-section with an extended tail fin. In some embodiments, the tether cross-section of FIG. 9 implements an active method for stable alignment of a tether. In the example shown, wind points at tether cross-section 900 in the direction indicated by arrows 906, towards the bottom of the page. Tail fin 904 is connected to tether 900 with extension 902. In the event that the tether is not aligned with respect to an incident wind, the angle of tail fin 904 is controlled by the active control system in such a way as to cause a realignment of the tether with respect to the incident wind Extension 902 causes the moment arm from the center of rotation of the tether to the tail fin to be considerably longer than it would be without the extension. The tail fin therefore has a larger effect than it would if it were mounted directly on the tether. Alternatively, moving the tail fin back allows the tether to be designed with the center of rotation further back for a desired moment arm length. Moving the center of rotation further back increases the load-bearing fraction of the tether, reducing the effective load on any load-bearing point of the tether.

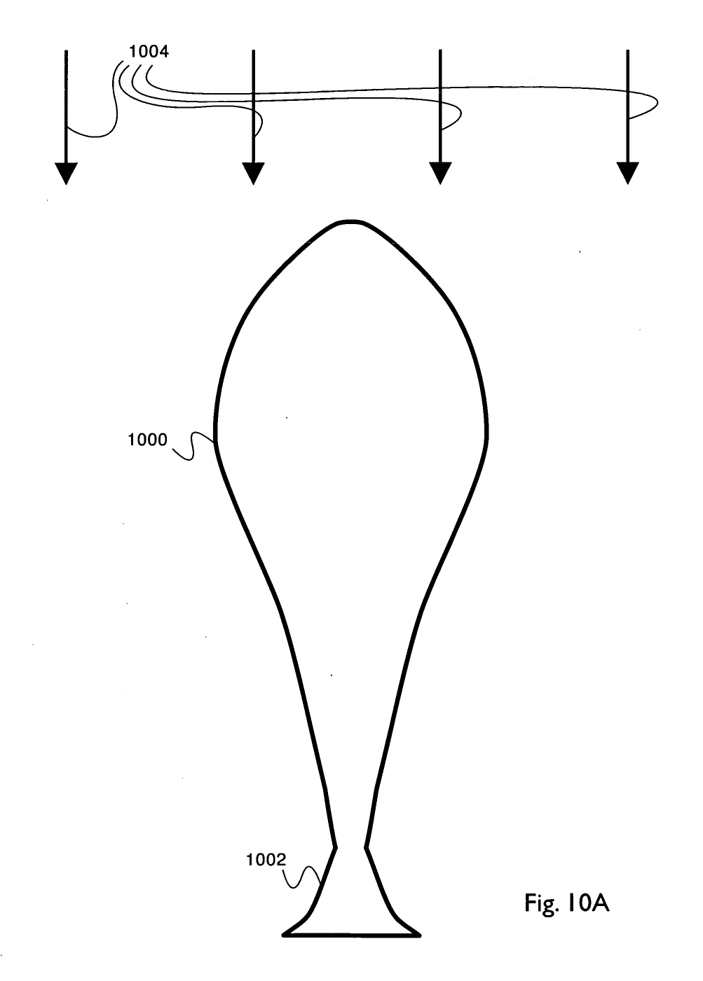

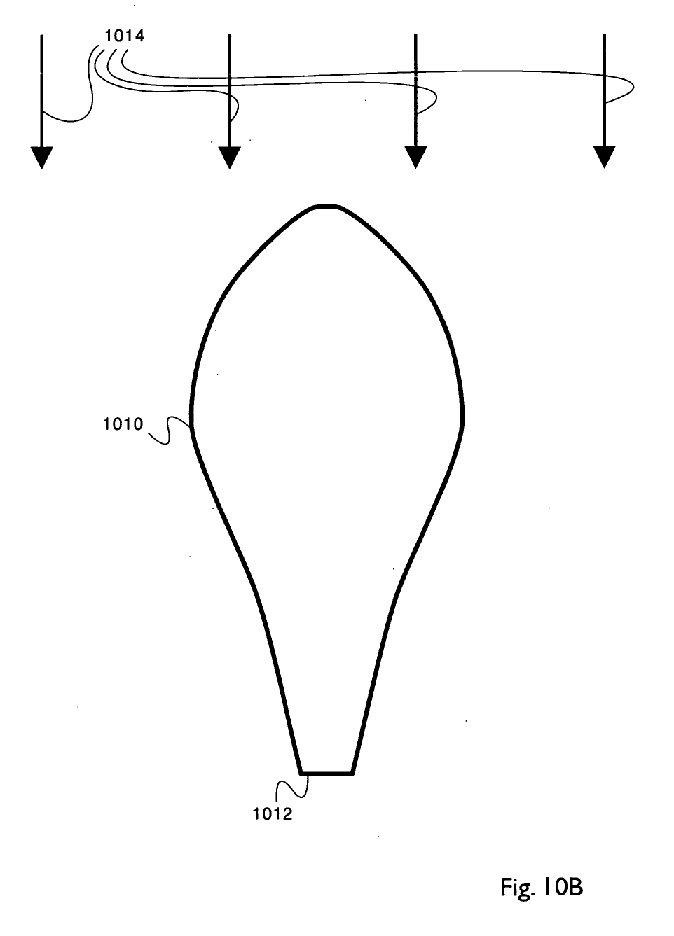

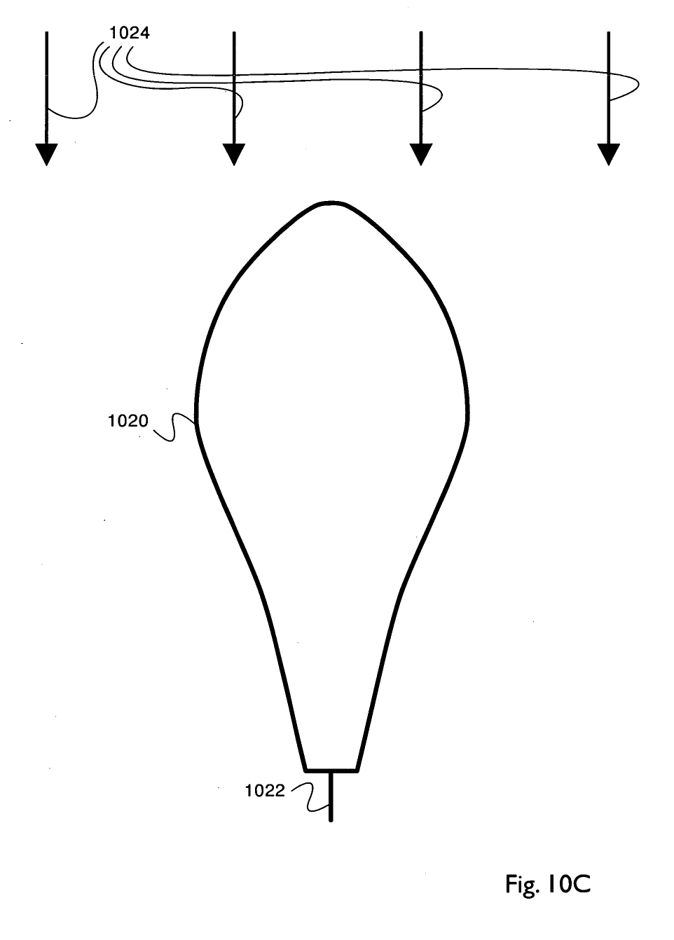

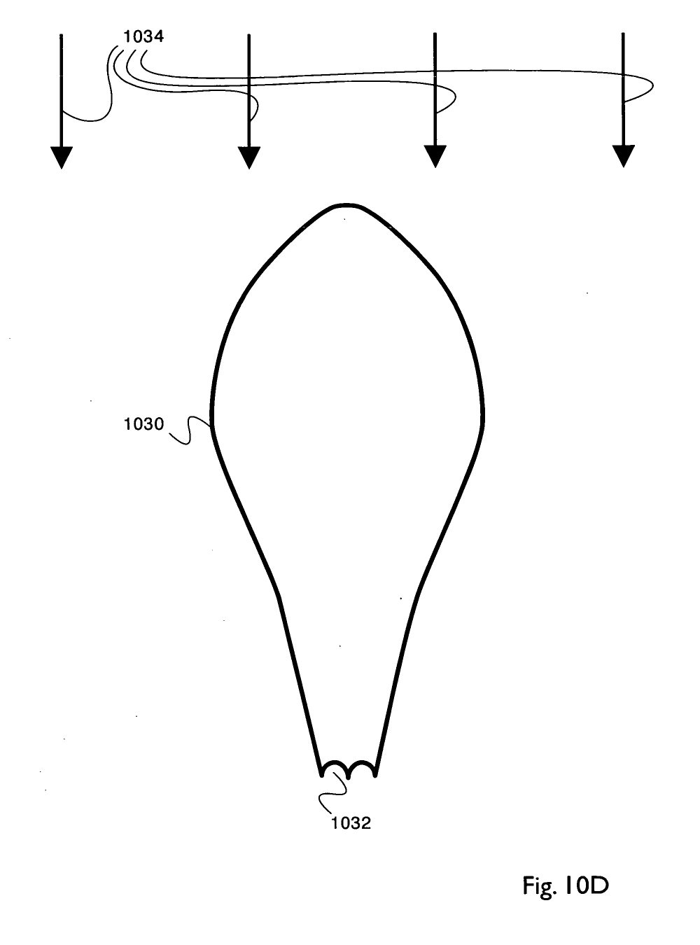

FIG. 10A is a diagram illustrating an embodiment of a tether cross-section with a static tail design. In some embodiments, the tether cross-section of FIG. 10A implements a passive method for stable alignment of a tether. In the example shown, wind points at tether cross-section 1000 in the direction indicated by arrows 1004, towards the bottom of the page. In some embodiments, tail 1002 is a fixed shape, angling outwards from the main body of the tether. Tail 1002 creates an aerodynamic center located at the rear of the tether, behind the tether center of rotation, such that in the event that the tether is not aligned with respect to an incident wind, air pressure causes a realignment of the tether with respect to the incident wind.

FIG. 10B is a diagram illustrating an embodiment of a tether cross-section with a static tail design. In some embodiments, the tether cross-section of FIG. 10B implements a passive method for stable alignment of a tether. In the example shown, wind points at tether cross-section 1010 in the direction indicated by arrows 1014, towards the bottom of the page. In some embodiments, tail 1012 comprises a flat side at the tether trailing edge, perpendicular to the direction of oncoming wind. Tail 1012 creates an aerodynamic center at the rear of the tether, located behind the tether center of rotation, such that in the event that the tether is not aligned with respect to an incident wind, air pressure causes a realignment of the tether with respect to the incident wind.

FIG. 10C is a diagram illustrating an embodiment of a tether cross-section with a static tail design. In some embodiments, the tether cross-section of FIG. 10C implements a passive method for stable alignment of a tether. In the example shown, wind points at tether cross-section 1020 in the direction indicated by arrows 1024, towards the bottom of the page. In some embodiments, tail 1022 comprises a flat side at the tether trailing edge, perpendicular to the direction of oncoming wind. Tail 1022 additionally comprises a straight tail fin aligned with the central axis of the tether, extending from the rear of the tether. Tail 1022 creates an aerodynamic center located at the rear of the tether, behind the tether center of rotation, such that in the event that the tether is not aligned with respect to an incident wind, air pressure causes a realignment of the tether with respect to the incident wind.

FIG. 10D is a diagram illustrating an embodiment of a tether cross-section with a static tail design. In some embodiments, the tether cross-section of FIG. 10D implements a passive method for stable alignment of a tether. In the example shown, wind points at tether cross-section 1030 in the direction indicated by arrows 1034, towards the bottom of the page. In some embodiments, tail 1032 comprises two substantially semicircular channels in the tail trailing edge that form a tail fin aligned with the central axis of the tether. Tail 1032 creates an aerodynamic center located at the rear of the tether, behind the tether center of rotation, such that in the event that the tether is not aligned with respect to an incident wind, air pressure causes a realignment of the tether with respect to the incident wind.

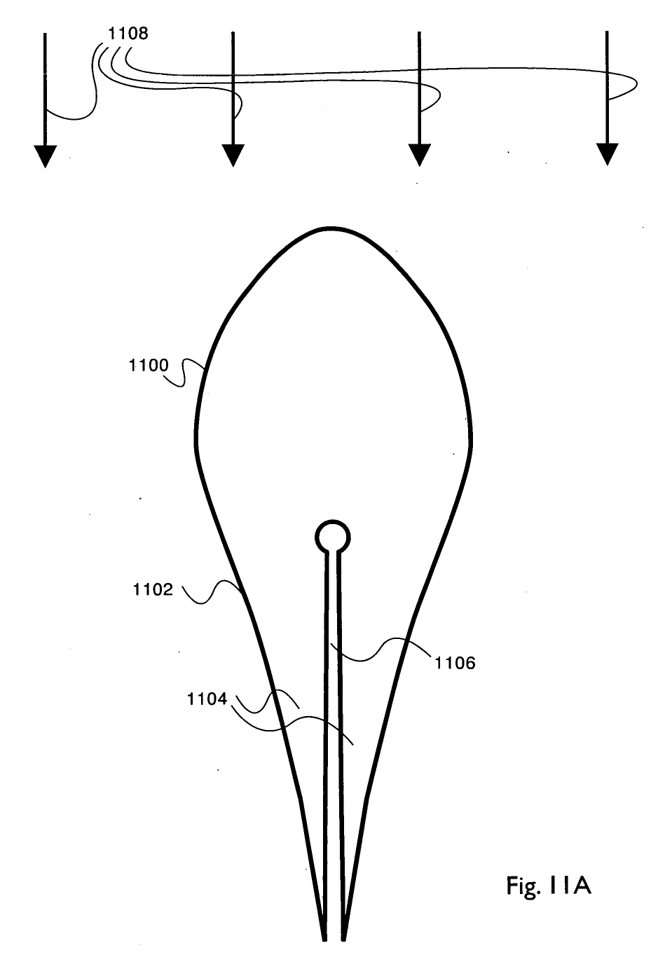

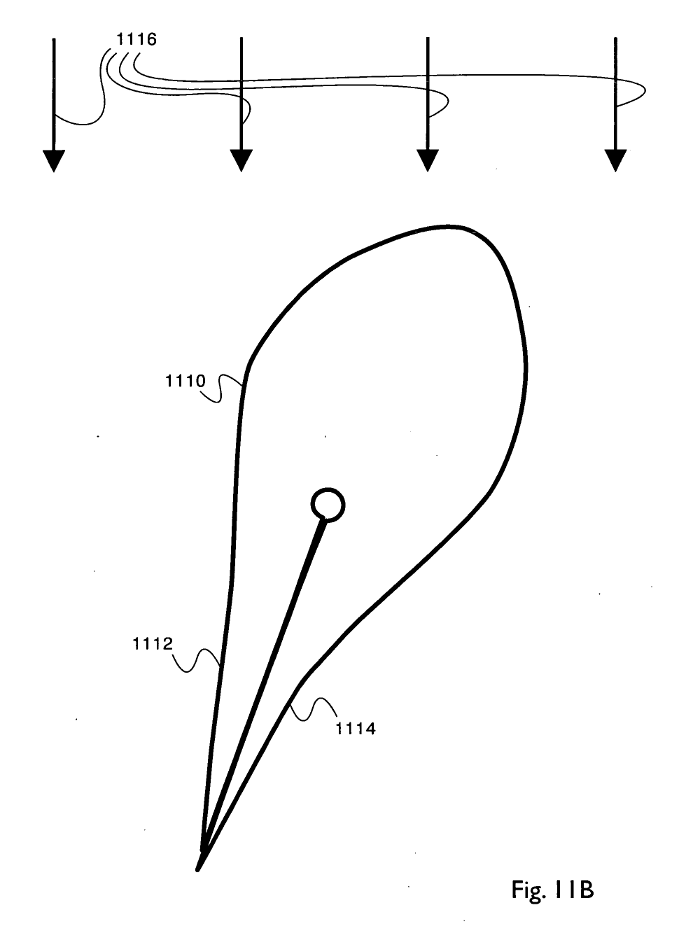

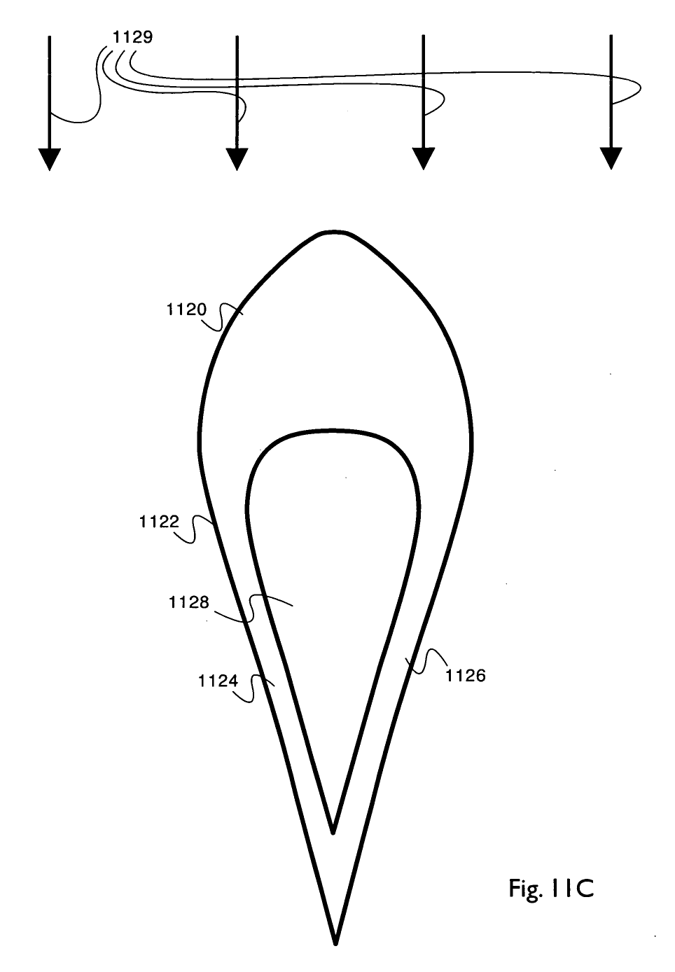

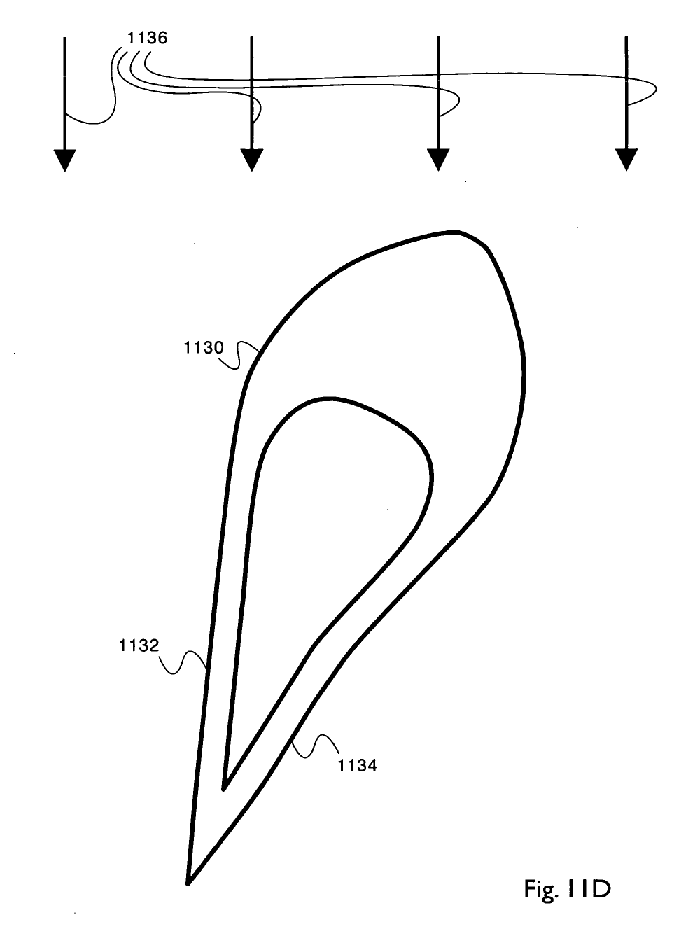

FIG. 11A is a diagram illustrating an embodiment of a tether cross-section with a flexible tail design. In some embodiments, the tether cross-section of FIG. 11A implements a passive method for stable alignment of a tether. In the example shown, wind points at tether cross-section 1100 in the direction indicated by arrows 1108, towards the bottom of the page. Flexible tail 1102 comprises flexible tail flaps 1104 and cut 1106. Cut 1106 gives flexible tail flaps 1104 room to bend under air pressure from wind 1108. When flexible tail flaps 1104 bend under air pressure from an incident wind, they shift the aerodynamic center of the tether, such that in the event that the tether is not aligned with respect to the incident wind, the shift in the aerodynamic center causes a realignment of the tether with respect to the incident wind.

FIG. 11B is a diagram illustrating an embodiment of a tether cross-section with a flexible tail design. In the example shown, wind points at tether cross-section 1110 in the direction indicated by arrows 1116, towards the bottom of the page. Tether cross-section 1110 is aligned at an angle to the wind. Pressure from the oncoming wind has caused tail flap 1112 to bend towards the center of tether cross-section 1110. Tail flap 1112 in turn has pushed tail flap 1114 away from the center of tether cross-section 1110. The change in tether cross-section 1110 moves the tether aerodynamic center and causes air pressure to rotate tether cross-section 1110 such that it is aligned in the direction of the oncoming wind.

FIG. 11C is a diagram illustrating an embodiment of a tether cross-section with a flexible tail design. In some embodiments, the tether cross-section of FIG. 11C implements a passive method for stable alignment of a tether. In the example shown, wind points at tether cross-section 1120 in the direction indicated by arrows 1129, towards the bottom of the page. Flexible tail 1122 comprises flexible tail linkages 1124 and 1126 and gap 1128. Gap 1128 gives flexible tail flaps 1124 and 1126 room to bend under air pressure from wind. When flexible tail flaps 1124 and 1126 bend under air pressure from an incident wind, they cause a shift in an aerodynamic center of the tether, such that in the event that the tether is not aligned with respect to the incident wind, the shift in the aerodynamic center causes a realignment of the tether with respect to the incident wind.

FIG. 11D is a diagram illustrating an embodiment of a tether cross-section with a flexible tail design. In the example shown, wind points at tether cross-section 1130 in the direction indicated by arrows 1136, towards the bottom of the page. Tether cross-section 1130 is aligned at an angle to the wind. Pressure from the oncoming wind has caused tail linkages 1132 and 1134 to bend. The change in tether cross-section 1130 moves the tether aerodynamic center and causes air pressure to rotate tether cross-section 1130 such that it is aligned in the direction of the oncoming wind.

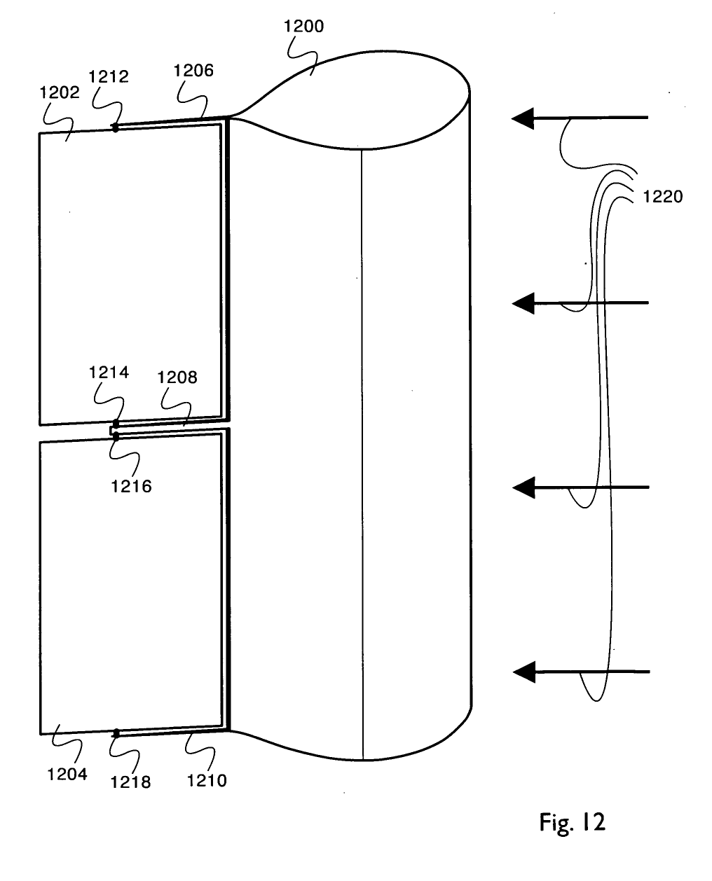

FIG. 12 is a diagram illustrating an embodiment of a tether with passive tail flaps. In some embodiments, the tether cross-section of FIG. 12 implements a passive method for stable alignment of a tether. In the example shown, wind points at tether cross-section 1200 in the direction indicated by arrows 1220, towards the left of the page. Tether 1200 comprises passive tail flaps 1202 and 1204 held to tether 1200 by tail extensions 1206, 1208, and 1210. Tail flaps 1202 and 1204 are fastened to tail extensions 1206, 1208, and 1210 by hinges 1212, 1214, 1216, and 1218. Flaps 1202 and 1204 can rotate on hinges 1212, 1214, 1216, and 1218 about an axis perpendicular to the direction of wind. When tail flaps 1202 and 1204 rotate under air pressure from an incident wind 1220, they shift the aerodynamic center of the tether, such that in the event that the tether is not aligned with respect to the wind, the shift in the aerodynamic center causes a realignment of the tether with respect to the incident wind.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A tether for a kite wind power system, comprising:
a tether, wherein the tether has a cross-section that is designed to have less aerodynamic drag than a tether with a circular-shaped cross-section.

2. A tether as in claim 1, wherein the tether is designed to stably align itself with respect to the wind.

3. A tether as in claim 2, wherein the tether includes two or more flexural skins, wherein the two or more flexural skins are coupled to two or more positions located symmetrically with respect to the cross-section of the tether, and wherein the two or more flexural skins change shape in the event that the tether is not aligned with respect to an incident wind in such a way as to cause a realignment of the tether with respect to the incident wind.

4. A tether as in claim 2, wherein the tether comprises:
a first inlet hole and a second inlet hole, wherein the first inlet hole and the second inlet hole are located symmetrically with respect to the cross-section of the tether;
a first outlet hole and a second outlet hole, wherein the first outlet hole and the second outlet hole are located symmetrically with respect to the cross-section of the tether;
a first coupler coupling the first inlet hole and the second outlet hole;
a second coupler coupling the second inlet hole and the first outlet hole; wherein air pressure associated with the first inlet hole and the second inlet hole causes air pressure associated with the first outlet hole and the second outlet hole to align the tether with respect to an incident wind.

5. A tether as in claim 4, wherein:
the first coupler includes a first fluidic logic unit; and
the second coupler includes a second fluidic logic unit;

6. A tether as in claim 2, wherein the tether comprises a shaft, a bearing, and a body, wherein the body is enabled to rotate freely around the shaft by the bearing.

7. A tether as in claim 2, wherein the tether comprises one or more materials, wherein the one or more materials are distributed within the tether such that a center of rotation of the tether is forward of an aerodynamic center of the tether, such that in the event that the tether is not aligned with respect to an incident wind, air pressure causes a realignment of the tether with respect to the incident wind.

8. A tether as in claim 2, wherein the tether includes a static tail that angles outward from the main body of the tether, wherein the static tail creates an aerodynamic center at the rear of the tether such that in the event that the tether is not aligned with respect to an incident wind, air pressure causes a realignment of the tether with respect to the incident wind.

9. A tether as in claim 2, wherein the tether includes a static tail comprising a flat side at a trailing edge of the tether, wherein the static tail creates an aerodynamic center at the rear of the tether such that in the event that the tether is not aligned with respect to an incident wind, air pressure causes a realignment of the tether with respect to the incident wind.

10. A tether as in claim 2, wherein the tether includes a static tail comprising a flat side at a trailing edge of the tether and a straight tail fin aligned with a central axis of the tether, wherein the static tail creates an aerodynamic center at the rear of the tether such that in the event that the tether is not aligned with respect to an incident wind, air pressure causes a realignment of the tether with respect to the incident wind.

11. A tether as in claim 2, wherein the tether includes a static tail comprising two substantially semicircular channels in a tail trailing edge of the tether that form a tail fin aligned with the central axis of the tether, wherein the static tail creates an aerodynamic center at the rear of the tether such that in the event that the tether is not aligned with respect to an incident wind, air pressure causes a realignment of the tether with respect to the incident wind.

12. A tether as in claim 2, wherein the tether includes a flexible tail comprising two or more flexible flaps able to bend under air pressure from an incident wind, wherein the flexible tail causes a shift in an aerodynamic center of the tether such that in the event that the tether is not aligned with respect to the incident wind, the shift in the aerodynamic center causes a realignment of the tether with respect to the incident wind.

13. A tether as in claim 2, wherein the tether includes a flexible tail comprising one or more flexible linkages able to bend under air pressure from an incident wind, wherein the flexible tail causes a shift in an aerodynamic center of the tether such that in the event that the tether is not aligned with respect to the incident wind, the shift in the aerodynamic center causes a realignment of the tether with respect to the incident wind.

14. A tether as in claim 2, wherein the tether includes one or more passive tail flaps mounted on hinges on tail extensions, able to rotate about an axis perpendicular to the direction of wind, wherein the one or more passive tail flaps causes a shift in an aerodynamic center of the tether such that in the event that the tether is not aligned with respect to the incident wind, the shift in the aerodynamic center causes a realignment of the tether with respect to the incident wind.

15. A tether as in claim 1, further comprising:
an active control system, wherein the active control system causes the tether to stably align the tether with respect to an incident wind.

16. A tether as in claim 15, wherein the tether includes two or more flexural skins, wherein the two or more flexural skins are coupled to two or more positions located symmetrically with respect to the cross-section of the tether, and wherein in the event that the tether is not aligned with respect to an incident wind, the two or more flexural skins are controlled by the active control system in such a way as to cause a realignment of the tether with respect to the incident wind.

17. A tether as in claim 15, wherein the tether includes a tail flap located at a trailing edge of the tether, wherein in the event that the tether is not aligned with respect to an incident wind, the angle of the tail flap is controlled by the active control system in such a way as to cause a realignment of the tether with respect to the incident wind.

18. A tether as in claim 15, wherein the tether includes a tail flap mounted on an extension located at a trailing edge of the tether, wherein in the event that the tether is not aligned with respect to an incident wind, the angle of the tail flap is controlled by the active control system in such a way as to cause a realignment of the tether with respect to the incident wind.

19. A tether as in claim 15, wherein the tether includes one or more flaps coupled to a surface of the tether, wherein, in the event that the tether is not aligned with respect to an incident wind, the angle of the flaps is controlled by the active control system in such a way as to cause a realignment of the tether with respect to the incident wind.

20. A tether as in claim 1, wherein the tether is designed to stably align itself with respect to an incident wind using a combination of active and passive means.

21. A tether as in claim 1, wherein the tether cross-section changes over the length of the tether.
